(19) United States
(12) Patent Application Publication
(10) Pub. No.: US 2026/0235436 A1
(43) Pub. Date: Aug. 13, 2026

(54) DEVICE FOR COUNTING A NUMBER OF MECHANICAL CYCLES PRODUCED BY A CYCLICALLY MOVING PART, AND ASSOCIATED METHODS AND AIRCRAFT

(71) Applicant: SAFRAN NACELLES, Gonfreville-L'Orcher (FR)

(72) Inventor: Olivier Meriel, Moissy-Cramayel (FR)

(73) Assignee: SAFRAN NACELLES, Gonfreville-L'Orcher (FR)

(21) Appl. No.: 19/150,767

(22) PCT Filed: Jan. 26, 2024
(86) PCT No.: PCT/FR2024/050110

§ 371 Date: Jul. 24, 2025

(30) Foreign Application Priority Data
Jan. 31, 2023 (FR) 2300868

(51) Int. Cl. G01H 11/08; G07C 3/04

(52) U.S. Cl. CPC G01H 11/08; G07C 3/04

(57) ABSTRACT

This device for counting a number of mechanical cycles performed by a moving part in cyclic movement, comprises a storage module of the number of mechanical cycles performed by the moving part, a module for detecting a mechanical cycle performed by the moving part able to increment the number stored in the storage module, and a module for transmitting the stored number on demand able to retrieve the number stored in the storage module, the detection module comprising a piezoelectric generator configured to determine a performance of a mechanical cycle by the moving part, and the module for transmitting on demand comprising an RFID tag equipped with an antenna.

### TECHNICAL FIELD

The invention relates, generally, to data acquisition systems in the aeronautical field, and relates more particularly to a device for counting a number of mechanical cycles performed by a moving part in cyclic movement.

In particular, the invention relates to such a counting device requiring neither an on-board battery nor a wired connection.

### PRIOR ART

The environment of an aircraft engine is very crowded and includes a lot of equipment to monitor, whether to maintain the aircraft, to assist control or to help diagnose a possible technical problem.

In order to monitor this equipment, sensors are installed in the engine environment to detect and retrieve data relating to the observed equipment. These sensors must meet several constraints, including size constraints in order to be able to be integrated into the engine environment, and position constraints requiring the sensors to be positioned close to the equipment in order to be able to capture said data.

So-called “passive” sensors requiring no onboard battery or wired connection have been developed to meet these constraints.

These sensors rely mainly on two technologies.

The first technology is piezoelectric technology. The piezoelectric sensors comprise a piezoelectric generator capable of converting a mechanical force undergone into an electric current.

The second technology is radio identification, commonly referred to as RFID, standing for the English term “radio-frequency identification”. This technology works using an RFID tag and an RFID reader emitting electromagnetic waves such as interrogation requests for the RFID tag.

So-called “passive” RFID tags operate without an onboard battery and without a wired connection, and draw their energy from the electromagnetic wave emitted by the RFID reader. RFID technology allows a variety of data such as temperature, voltage, humidity or pressure to be measured.

Among the sensors used in the aeronautical industry, so-called counting sensors are used to count a number of mechanical cycles performed by a part in cyclic movement, i.e. a part periodically performing the same movement. A mechanical cycle is understood to mean the movement or part of the movement performed periodically in the same way by the part. For example, a mechanical cycle of a part in circular cyclic movement around a centre point may be a complete revolution around the centre point of the part.

A sensor using piezoelectric technology has the major drawback of only being activated when mechanical force is applied to the piezoelectric generator. Thus, such a sensor does not allow a subsequent or on-demand verification of the counted number of mechanical cycles performed by the part. A wireless or battery-operated counting sensor using piezoelectric technology is therefore not reliable enough.

Moreover, the very nature of a passive RFID tag means that it is only capable of functioning when the RFID reader emits electromagnetic waves. Indeed, if an event to be counted by a counting sensor using RFID technology occurs when the tag is not interrogated by the RFID reader, this event cannot be detected and counted by the tag.

There is therefore no solution for a device for counting a number of cycles performed by a part in cyclic movement requiring neither an on-board battery nor a wired connection.

The present invention therefore aims to overcome the aforementioned drawbacks and to propose such a counting device.

The present invention therefore relates to a device for counting a number of mechanical cycles performed by a moving part in cyclic movement, comprising a module for storing the number of mechanical cycles performed by the moving part, a module for detecting a mechanical cycle performed by the moving part able to increment the number stored in the storage module, and a module for transmitting on demand the stored number able to retrieve the number stored in the storage module.

The detection module comprises a piezoelectric generator configured to determine a performance of a mechanical cycle by the moving part, and the on-demand transmission module comprises an RFID tag equipped with an antenna.

Advantageously, the piezoelectric generator comprises a contact key configured to transmit at the input of the piezoelectric generator a force exerted by the moving part during a mechanical cycle.

Preferentially, the module for detecting a mechanical cycle carried out by the moving part comprises a first voltage regulator, a first reset system, a first internal clock and a first calculator capable of incrementing the number stored in the storage module.

Advantageously, the first voltage regulator receives at the input an electric current generated by the piezoelectric generator and delivers at the output a direct voltage for supplying the first calculator.

Preferentially, the RFID tag is a passive RFID tag, and comprises a second calculator configured to retrieve the number stored in the storage module and to transmit said retrieved number when a correct interrogation request is received by said RFID tag. The invention also relates to a method for counting a number of mechanical cycles performed by a moving part in cyclic movement, capable of being implemented by a counting device as defined previously, the counting device comprising a first voltage regulator, a first reset system, a first internal clock and a first calculator.

The counting method comprises the following steps:
Activation of the piezoelectric generator by a movement of the moving part,
Generation of an electric current by the piezoelectric generator,
Transmission of the electric current generated to the first voltage regulator,
Transmission of the electric current generated to the first reset system,
Direct-voltage supply of the first internal clock and of the first calculator by the first voltage regulator,
Sending of time information by the first internal clock to the first calculator,
Initialisation or reset of the first calculator,
Retrieval of the number stored in the storage module by the first calculator, and
Incrementation of the stored number retrieved by the first calculator.

The invention also relates to a method for transmitting a number of mechanical cycles performed by a moving part in cyclic movement capable of being implemented by a counting device as described previously, and comprising an antenna and a second calculator.

The transmission method comprises the following steps:
Reception by the antenna of an interrogation request about the number of mechanical cycles performed by the moving part, the request being made by an RFID reader,
Processing of the interrogation request,
Retrieval in the storage module by the second calculator of the stored number,
Preparation of a response to the interrogation request by the second calculator, the response comprising the stored number of mechanical cycles performed by the moving part retrieved in the storage module.
Transmission of the prepared response to the RFID reader via the antenna.

Advantageously, the step of processing the interrogation request comprises the following sub-steps:
Transmission of the interrogation request by the antenna to the converter and to the demodulator,
Demodulation of the interrogation request, Supply of the second voltage regulator and of the second reset system by the converter,
Supply of the second clock and of the second calculator by the second voltage regulator,
Transmission of time information by the second internal clock to the second calculator,
Sending an initialisation or reset signal by the second reset system to the second calculator,
Initialisation or reset of the second calculator,
Transmission of the demodulated request to the second calculator, and
Verification of the validity of the interrogation request.

Preferentially, the step of transmitting the prepared response to the RFID reader comprises the following sub-steps:
Transmission by the second calculator of the prepared response comprising the stored number recovered to a retro-modulator,
Modulation of the response by the retro-modulator,
Transmission of the modulated response to the RFID reader via the antenna.

Finally, the invention also relates to an aircraft comprising a counting device as defined previously, the counting device being able to implement a counting method as defined previously and/or a transmission method as defined previously.

### BRIEF DESCRIPTION OF THE DRAWINGS

Other aims, features and advantages of the invention will become apparent upon reading the following description, given merely as a non-limiting example, and made with reference to the appended drawings, wherein:

FIG. 1 illustrates a device for counting a number of mechanical cycles performed by a part in cyclic movement according to the invention;

FIG. 2 schematically illustrates the device of FIG. 1;

FIG. 3 illustrates a plan view of the device of FIG. 1;

FIG. 4 schematically illustrates the exchanges of electrical signals when the device of FIG. 1 implements a counting method according to the invention; and

FIG. 5 schematically illustrates the exchanges of electrical signals when the device of FIG. 1 implements a method for transmitting the counted value according to the invention.

FIG. 6 schematically illustrates the steps of the method for counting the number of cycles performed according to the invention; and

FIG. 7 schematically illustrates the steps of the method for transmitting the number of cycles performed counted according to the invention.

### DETAILED DISCLOSURE OF AT LEAST ONE EMBODIMENT

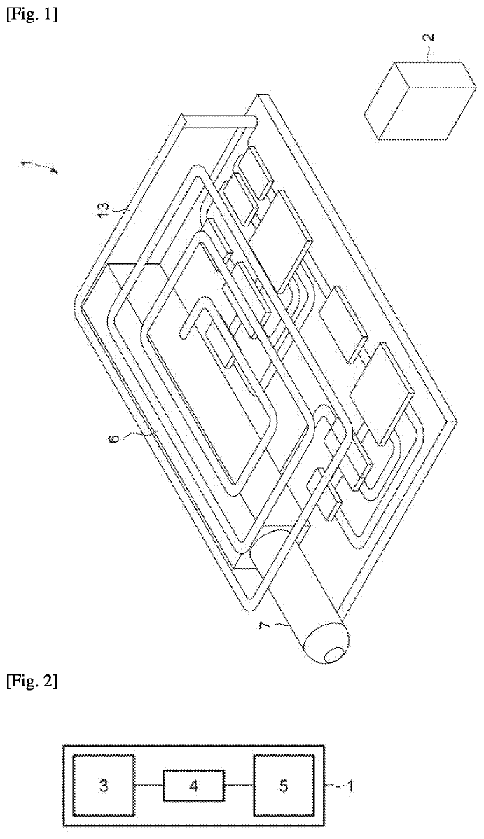

FIG. 1 shows a device 1 for counting a number of mechanical cycles performed by a moving part in cyclic movement and a remote radio-identification reader, called remote RFID reader 2.

The moving part is for example a mechanical element of an aeronautical component in cyclic movement, i.e. repeatedly performing an identical movement. The moving part is not shown in the figures.

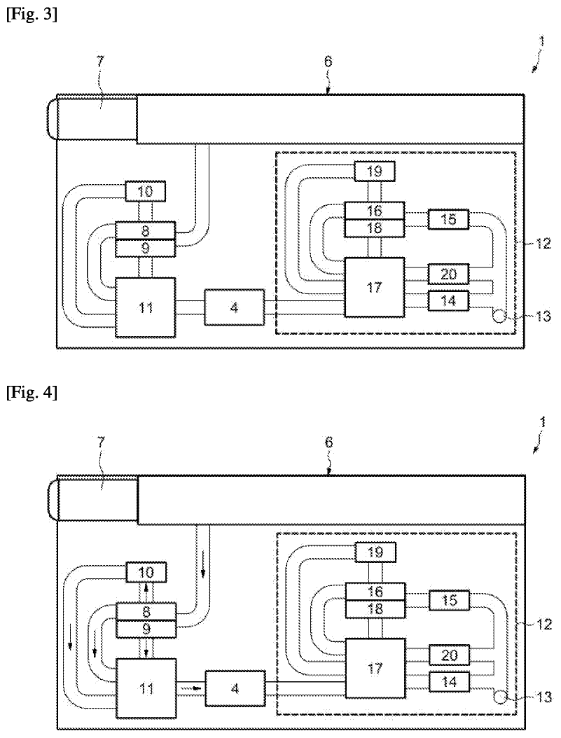

The counting device 1 is shown schematically in FIG. 2, and is shown seen from above in FIG. 3.

The counting device 1 comprises a module 3 for detecting a mechanical cycle performed by the moving part, a module 4 for storing the number of mechanical cycles performed by the moving part, and a module 5 for transmitting on demand the number stored in the storage module 4, delivering the number of mechanical cycles in response to an interrogation request transmitted by the remote RFID reader 2.

The module 3 for detecting a mechanical cycle performed is able to increment the number stored in the storage module 4, and the module 5 for transmitting the stored number on demand is able to retrieve the number stored in the storage module 4.

Thus the storage module 4 is connected directly to the detection module 3 on the one hand and to the request transmission module 5 on the other hand.

The module 3 for detecting a mechanical cycle performed comprises a piezoelectric generator 6 equipped with a contact key 7. The piezoelectric generator 6 generates an electric current from a sufficiently high mechanical force to which the contact key 7 is subjected.

The moving part performs a cyclic mechanical movement compatible with the generation of an electric current by the piezoelectric generator 6. In other words, the moving part repeatedly performs a periodic spatial movement during which it comes into contact with the key 7 of the piezoelectric generator 6. The piezoelectric generator 6 is therefore configured to determine a performance of a mechanical cycle performed by the moving part.

The detection module 3 further comprises a first voltage regulator 8, a first integrated circuit reset system 9, a first internal clock 10 and a first calculator 11 capable of incrementing the number stored in the storage module 4.

The first voltage regulator 8 is directly connected to the output of the piezoelectric generator 6 so that the piezoelectric generator 6 is able to deliver an electric current generated to the first voltage regulator 8.

The first voltage regulator 8 is connected at the output on the one hand to the first internal clock 10 and on the other hand to the first calculator 11.

The first voltage regulator 8 therefore receives at the input the electric current generated by the piezoelectric generator 6 and delivers at the output a direct voltage adapted for supplying the first calculator 11 and for supplying the first internal clock 10.

The first reset system of the calculator 9 is also directly connected to the output of the piezoelectric generator 6 so that the piezoelectric generator 6 delivers an electric current generated at the input of the first reset system 9. The first reset system 9 is further directly connected to the first output calculator 11.

The first reset system 9 is a system also known as POR, an abbreviation of the English term “Power-on Reset”, and is configured to initialise or reset the first calculator 11 when an electric current is applied to the system 9.

The first reset system 9 therefore receives as input the electric current generated by the piezoelectric generator 6 and resets the first calculator 11.

The first internal clock 10 is configured to send time information to the first calculator 11 in order to allow synchronisation of the tasks performed by the first calculator 11.

The first calculator 11 is an integrated circuit capable of consulting the number stored in the storage module 4, of incrementing said number, and of writing the incremented number in the storage module 4. The first calculator 11 is thus directly connected to the storage module 4.

The counting device 1, and more particularly the detection module 3, counts the number of mechanical cycles performed by the moving part in cyclic movement.

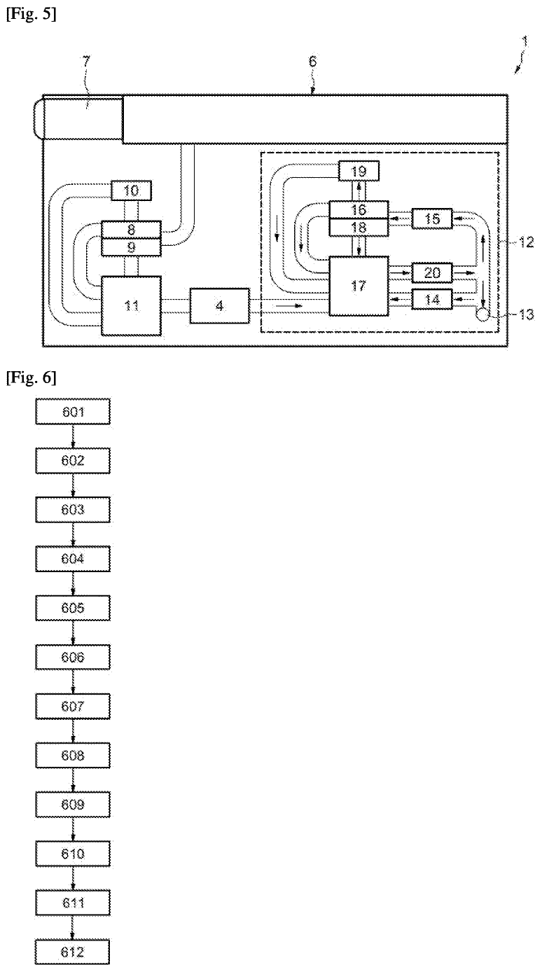

FIG. 6 illustrates the steps of a counting method implemented by the detection module to count the number of mechanical cycles performed by the moving part in cyclic movement.

In a first step 601, the piezoelectric generator 6 is activated by a movement of the moving part performing a mechanical cycle to be counted. More specifically, the contact key 7 is arranged on the path of the moving part in cyclic movement, which thus applies a mechanical force to the piezoelectric generator 6 sufficiently large for generating an electric current.

In the next step 602, the piezoelectric generator 6 generates an electric current and transmits this current to the first voltage regulator 8 (step 603) and to the first reset system 9 (step 604).

In step 605, the first voltage regulator 8 is activated by the supply of electric current and transforms the electric current received as input into a direct voltage as output,

In a step 606, the first voltage regulator 8 supplies the first internal clock 10 on the one hand and the first calculator 11 on the other hand with direct voltage in parallel.

At the same time, i.e. while the first voltage regulator 8 supplies the first calculator 11 and the internal clock 10, the first internal clock 10 sends time information (step 607), while the first reset system 9 sends an initialisation or reset signal to the first calculator 11 (step 608) allowing the initialisation of the calculator 11 (step 609).

During the next step 610, the first calculator 11 then retrieves the counted number of cycles performed that is stored in the storage module 4, increments the number retrieved (step 611), and writes the incremented number in the storage module 4 (step 612).

FIG. 4 illustrates the exchanges of electrical signals when the device of FIG. 1 implements the counting method illustrated in FIG. 6.

The module 5 for transmitting the stored number on demand comprises a radio-identification tag called RFID tag 12 equipped with an antenna 13.

The antenna 13 is illustrated in FIG. 1, and has not been included in the other figures for the sake of clarity.

The antenna 13 is an antenna conventionally used in the field of radio identification. The antenna 13 is thus able to receive an electromagnetic wave sent by an RFID reader not shown in the figures and to transform the received electromagnetic wave into an electrical signal.

The RFID tag 12 is a conventional passive RFID tag, i.e. devoid of an onboard battery and powered only by an electromagnetic wave emitted by the remote RFID reader and picked up by the antenna 13.

The RFID tag 12 comprises a demodulator 14, a converter 15, a second voltage regulator 16, a second calculator 17, a second system 18 for resetting the second calculator 17, a second internal clock 19 and a retro-modulator 20.

The demodulator 14 and the converter 15 are each directly connected to the output of the antenna 13 so that the antenna 13 delivers the electrical signal resulting from the electromagnetic wave at the input of the demodulator 14 and of the converter 15.

The converter 15 converts the electrical signal received by the antenna 13 into a direct current. The converter 15 outputs the converted direct current in parallel with the second voltage regulator 16, on the one hand, and the second reset system 18, on the other hand.

Thus the second voltage regulator 16 is directly connected to the output of the converter 15 so that the converter 15 delivers an electric current to the second voltage regulator 16.

The second voltage regulator 16 is connected at the output to the second internal clock 19 on the one hand and to the second calculator 17 on the other hand.

The second voltage regulator 16 therefore receives at the input the electric current generated by the converter 15 and is able to deliver at the output a direct voltage adapted for supplying the second calculator 17 and for supplying the second internal clock 19.

The second system 18 for resetting the second calculator is also directly connected to the output of the converter 15 so that the converter 15 delivers an electric current generated at the input of the second reset system 18. The second reset system 18 is further connected directly to the second calculator 17 at the output.

The second reset system 18 is similar to the first reset system 9, i.e. it consists of a known system of the PoR type, the abbreviation of the English term “Power-on Reset”, capable of initialising or resetting the second calculator 17 when an electric current is applied to the second system 18.

The second reset system 18 therefore receives as input the electric current generated by the converter 15 and resets the second calculator 17.

The demodulator 14 is connected at the input to the antenna 13 and at the output to the second calculator 17.

The demodulator 14 demodulates the electrical signal received by the antenna 13 and provides the demodulated signal at the input of the second calculator 17. In other words, the demodulator 14 continuously converts and demodulates the signal received by the antenna 13 and sends it to the second calculator 17.

The second internal clock 19 is directly connected to the second calculator 17 and is configured to send time information to the second calculator 17 in order to allow synchronisation of the tasks performed by the second calculator 17.

The second calculator 17 is an integrated circuit capable of recovering the number stored in the storage module 4 and capable of transmitting said stored number recovered when a correct interrogation request is received by the RFID tag 12. In other words, the second calculator 17 is able to prepare a response to an interrogation request sent by the RFID reader about the stored number of cycles performed by the moving part.

The second calculator 17 is thus directly connected to the storage module 4 and to the retro-modulator 20.

The retro-modulator 20 is a component known to the passive RFID tags intended to modulate the response prepared by the second calculator 17 using the wave received from the RFID reader and picked up by the antenna 13.

The retro-modulator 20 is thus directly connected to the antenna 13 and provides the modulated response to the antenna 13 as output. The antenna 13 is capable of emitting an electromagnetic wave and transmitting the modulated response to the RFID reader.

The counting device 1, and more particularly the module 5 for transmitting the stored number on demand, ensures the transmission of the number of mechanical cycles performed by the moving part in cyclic movement.

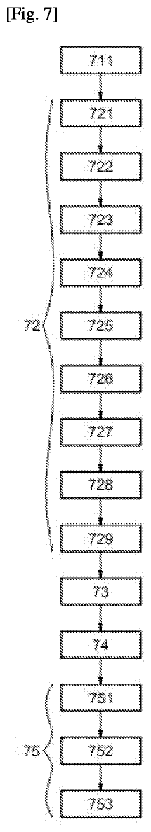

FIG. 7 illustrates the steps of such a method for transmitting a number of mechanical cycles performed by a moving part in cyclic movement.

During a first step 711, the antenna 13 receives as input an electromagnetic wave emitted by the RFID reader 2. The received electromagnetic wave comprises a request to interrogate the number of mechanical cycles performed by the moving part made by the RFID reader 2.

During a subsequent phase 72 of the method, the interrogation request is processed by the counting device 1, and more particularly by the module 5 for transmitting on demand. More precisely, during the phase 72 of processing the interrogation request by the module 5 for transmitting on demand, the antenna 13 delivers the electrical signal resulting from the electromagnetic wave received simultaneously at the input of the demodulator 14 and of the converter 15 (step 721) Then, in a second step 722 of the phase 72, the interrogation request is continuously demodulated by the demodulator 14.

In parallel with the step 722 of continuous demodulation produced by the demodulator 14, the converter 15 simultaneously supplies the second voltage regulator 16 and the second reset system 18 (step 723).

The second voltage regulator 16 then simultaneously supplies the second clock 19 and the second calculator 17 (step 724).

The second clock 19 sends time information (step 725), while the second reset system 18 sends an initialisation or reset signal to the second calculator 17 (step 726) allowing the initialisation or reset of the second calculator 17 (step 727).

The demodulated interrogation request is then sent to the second calculator 17 by the demodulator 14 (step 728). The second calculator 17 then checks the validity of the interrogation request demodulated by the demodulator 14 (step 729). In particular, it involves checking that the request is indeed intended for the RFID tag 12, and that it indeed contains a compliant interrogation about the number of mechanical cycles performed by the moving part. The verification step 729 is the last step of the phase 72.

If the demodulated request is valid, the second calculator 17 retrieves the number stored in the storage module 4 corresponding to the number of cycles performed by the moving part and counted by the counting device 1 (step 73).

During the next step 74, the second calculator prepares a response to the interrogation request transmitted by the RFID reader 2. More specifically, the response prepared by the second calculator 17 comprises the recovered number stored in the module 4 starring the number of mechanical cycles performed by the moving part. Finally, the antenna 13 transmits to the RFID reader 2 the response prepared in step 74 comprising the stored number of mechanical cycles performed by the moving part retrieved in step 73 (phase 75).

To do so, the response prepared in step 74 is transmitted to the retro-modulator 20 by the second calculator 17 (step 751), then the response is converted into a modulated signal called retro-modulated response by the retro-modulator 20 (step 752), and this retro-modulated response is transmitted by the antenna 13 to the RFID reader 2 (step 753).

FIG. 5 illustrates the exchanges of electrical signals when the device of FIG. 1 implements the transmission method illustrated in FIG. 7.

The counting device 1 therefore combines the radio-identification and piezoelectric technologies to propose a sensor for counting mechanical cycles performed by the moving part in cyclic movement, the counting of which is reliable and constantly consultable, the sensor requiring neither an on-board battery nor a wired connection for data portability and for power supply.

1. Device for counting a number of mechanical cycles performed by a moving part in cyclic movement, comprising a module for storing the number of mechanical cycles performed by the moving part, a module for detecting a mechanical cycle performed by the moving part able to increment the number stored in the storage module, and a module for transmitting the stored number on demand able to retrieve the number stored in the storage module, thatwherein the detection module comprises a piezoelectric generator configured to determine a performance of a mechanical cycle by the moving part, and the module for transmission on demand comprises an RFID tag equipped with an antenna.

2. Device according to claim 1, wherein the piezoelectric generator comprises a contact key configured to transmit at the input of the piezoelectric generator a force exerted by the moving part during a mechanical cycle.

3. Device according to claim 2, wherein the module protecting a mechanical cycle performed by the moving part comprises a first voltage regulator, a first reset system, a first internal clock and a first calculator capable of incrementing the number stored in the storage module.

4. Device according to claim 3, wherein the first voltage regulator receives an electric current generated by the piezoelectric generator at the input and delivers a direct voltage at the output for supplying the first calculator.

5. Device according to claim 1, wherein the RFID tag is a passive RFID tag, and comprises a second calculator configured to retrieve the number stored in the storage module and to transmit said retrieved number when a correct interrogation request is received by said RFID tag.

6. Method for counting a number of mechanical cycles performed by a moving part in cyclic movement, capable of being implemented by a device according to claim 1, the device comprising a first voltage regulator, a first reset system, a first internal clock and a first calculator, the method comprising the following steps:
Activation of the piezoelectric generator by a movement of the moving part;
Generation of an electric current by the piezoelectric generator;
Transmitting of the generated electric current to the first voltage regulator;
Transmission of the generated electric current to the first reset system ;
Supplying the first internal clock and the first calculator with direct voltage by the first voltage regulator;
Sending time information by the first internal clock to the first calculator;
Initialization or reset of the first calculator;
Retrieval of the number stored in the storage module by the first calculator; and
Incrementation of the stored number recovered by the first calculator.

7. Method for transmitting a number of mechanical cycles performed by a moving part in cyclic movement capable of being implemented by a device according to claim lany the device comprising an antenna and a second calculator, the method comprising the following steps:
Reception by the antenna of an interrogation request about the number of mechanical cycles performed by the moving part, the request being made by an RFID reader;
Processing of the interrogation request;
Retrieval in the storage module by the second calculator of the stored number;
Preparation of a response to the interrogation request by the second calculator, the response comprising the stored number of mechanical cycles performed by the moving part retrieved in the storage module.; and
Transmission of the processed response to the RFID reader by the antenna.

8. Method according to claim 7, wherein the step of processing the interrogation request comprises the following sub-steps:
Transmission of the interrogation request by the antenna to the converter and to the demodulator;
Demodulation of the interrogation request;
Supply of the second voltage regulator and of the second reset system by the converter;
Supply of the second clock and of the second calculator by the second voltage regulator;
Sending of time information by the second internal clock to the second calculator;
Sending of an initialisation or reset signal by the second reset system to the second calculator;
Initialization or reset of the second calculator;
Transmissionof the demodulated request to the second calculator; and
Verification of the validity of the interrogation request.

9. Method according to claim 7, wherein the device comprises a retro-modulator, the step of transmitting the response to the RFID reader comprising the following sub-steps:
Transmission by the second calculator of the prepared response comprising the stored number retrieved to the retro-modulator;
Modulation of the response by the retro-modulator; and
Transmission by the antenna of the modulated response to the RFID reader.

10. Aircraft comprising a device for counting a number of mechanical cycles performed by a moving part in cyclic movement, comprising a module for storing the number of mechanical cycles performed by the moving part, a module for detecting a mechanical cycle performed by the moving part able to increment the number stored in the storage module, and a module for transmitting the stored number on demand able to retrieve the number stored in the storage module, wherein the detection module comprises a piezoelectric generator configured to determine a performance of a mechanical cycle by the moving part, and the module for transmission on demand comprises an RFID tag equipped with an antenna, according the device being capable of implementing a method according to claim 6.
